(19) United States
(12) Patent Application Publication
(10) Pub. No.: US 2026/0316466 A1
(43) Pub. Date: Oct. 15, 2026

(54) IMAGE FORMING APPARATUS

(71) Applicant: KYOCERA Document Solutions Inc., Osaka (JP)

(72) Inventors: Kenichiro Kawasaki, Osaka (JP); Nobuyuki Hayashi, Osaka (JP); Takeshi Watanabe, Osaka (JP); Akihisa Mori, Osaka (JP); Sumire Nagoya, Osaka (JP)

(21) Appl. No.: 19/638,831

(22) Filed: Apr. 3, 2026

(30) Foreign Application Priority Data
Apr. 10, 2025 (JP) 2025-064691

(51) Int. Cl. B41J 13/08; B41J 2/17; B41J 29/17

(52) U.S. Cl. CPC B41J 13/08; B41J 2/1721; B41J 29/17; B41P 2235/21

(57) ABSTRACT

A recording head is configured to eject ink corresponding to an image to be printed. A transportation belt is configured to transport a print sheet on which the image to be printed is formed. A cleaning unit is configured to clean the transportation belt. A cleaning supporting member is configured to support the cleaning unit. Further, the transportation belt is hitched around the driving roller and the driven roller. Force is added to the driven roller toward a reverse direction to the driving roller. The cleaning unit makes contact with the transportation belt at a position opposite to the driven roller. The cleaning supporting member (a) is fixed to the cleaning unit and (b) is connected to a shaft of the driven roller such that the cleaning unit moves together with the driven roller and the shaft of the driven roller is rotatable.

### CROSS-REFERENCE TO RELATED APPLICATIONS

This application relates to and claims priority rights from Japanese Patent Application No. 2025-064691, filed on Apr. 10, 2025, the entire disclosures of which are hereby incorporated by reference herein.

### BACKGROUND

### 1. Field of the Present Disclosure

The present disclosure relates to an image forming apparatus.

### 2. Description of the Related Art

An inkjet image forming apparatus includes a transportation belt that transports a print sheet, a driving roller and a driven roller that rotate the transportation belt, a recording head arranged so as to face the transportation belt, and a cleaning unit that makes contact with the transportation belt at an opposite position to the driven roller and thereby cleans the transportation belt.

In an image forming apparatus, a transportation belt is hitched around a driving roller and a driven roller, the driving roller is fixed (to a housing, a frame or the like) and an elastic member adds force to the driven roller toward a reverse direction to the driving roller, and thereby tension is given to the transportation belt. In general, the cleaning unit is fixed to a housing, a frame or the like, and in such an image forming apparatus, the driven roller slightly moves correspondingly to a tension status of the transportation belt, and therefore, a contact pressure from the cleaning unit to the transportation belt varies and the transportation belt may not be favorably cleaned by the cleaning unit.

### SUMMARY

An image forming apparatus according to an aspect of the present disclosure includes a recording head, a transportation belt, a driving roller, a driven roller, a cleaning unit, and a cleaning supporting member. The recording head is configured to eject ink corresponding to an image to be printed. The transportation belt is configured to transport a print sheet on which the image to be printed is formed. The cleaning unit is configured to clean the transportation belt. The cleaning supporting member is configured to support the cleaning unit. Further, the transportation belt is hitched around the driving roller and the driven roller. Force is added to the driven roller toward a reverse direction to the driving roller. The cleaning unit makes contact with the transportation belt at a position opposite to the driven roller. The cleaning supporting member (a) is fixed to the cleaning unit and (b) is connected to a shaft of the driven roller such that the cleaning unit moves together with the driven roller and the shaft of the driven roller is rotatable.

These and other objects, features and advantages of the present disclosure will become more apparent upon reading of the following detailed description along with the accompanied drawings.

### BRIEF DESCRIPTION OF THE DRAWINGS

FIG. 1 shows a side-view diagram that indicates a configuration of an image forming apparatus according to an embodiment of the present disclosure;

FIG. 2 shows a perspective-view diagram that indicates an example of a driven roller 4 and a roller supporting member 5 in FIG. 1;

FIG. 3 shows a perspective-view diagram that indicates an example of a cleaning supporting member 11 in FIG. 1;

FIG. 4 shows a perspective-view diagram that indicates an example of the cleaning supporting member 11, a blade member 10a, and a blade supporting member 10b in FIG. 1; and

FIG. 5 shows a perspective-view diagram that indicates an example of an ink absorption member 12 in FIG. 1.

### DETAILED DESCRIPTION

Hereinafter, an embodiment according to an aspect of the present disclosure will be explained with reference to drawings.

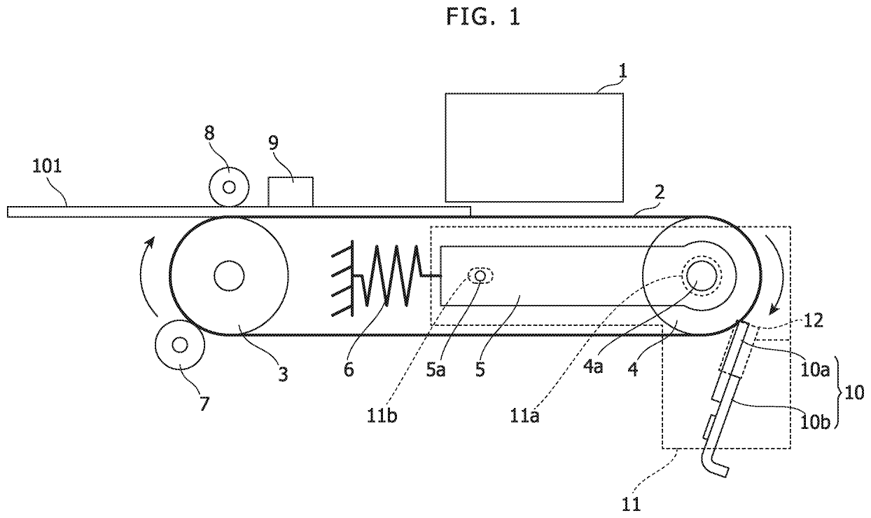

FIG. 1 shows a side-view diagram that indicates a configuration of an image forming apparatus according to an embodiment of the present disclosure. The image forming apparatus shown in FIG. 1 includes a recording head 1, a transportation belt 2, a driving roller 3, a driven roller 4, a roller supporting member 5, an elastic member 6, a charging roller 7, an absorption roller 8, a discharging brush 9, a cleaning unit 10, a cleaning supporting member 11, and an ink absorption member 12.

The recording head 1 ejects ink corresponding to an image to be printed.

The transportation belt 2 transports a print sheet 101 on which the image to be printed is formed. Specifically, the transportation belt 2 causes the print sheet 101 to pass at an ink ejection position of the recording head 1.

The transportation belt 2 is hitched around the driving roller 3 and the driven roller 4; and the driving roller 3 is rotatably fixed to a housing, a frame or the like and is driven by a motor or the like and thereby rotates the transportation belt 2. Further, the driven roller 4 is not fixed to the housing, the frame or the like, and force is added to the driven roller 4 toward a reverse direction to the driving roller 3.

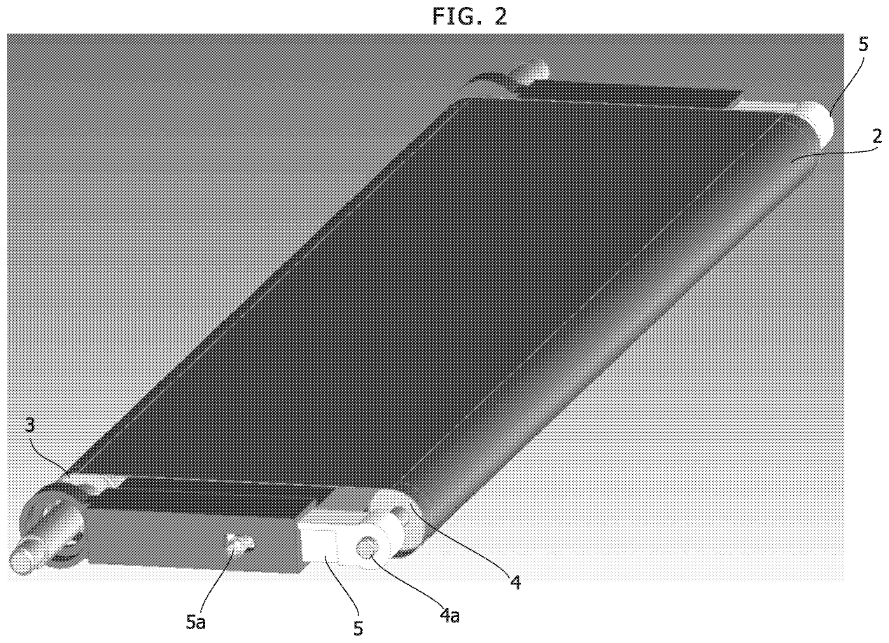

FIG. 2 shows a perspective-view diagram that indicates an example of a driven roller 4 and a roller supporting member 5 in FIG. 1. As shown in FIG. 2 for example, the roller supporting member 5 supports a shaft 4a of the driven roller 4 such that the shaft 4a of the driven roller 4 is rotatable.

Further, the elastic member 6 is connected to the roller supporting member 5, and adds force to the driven roller 4 through the roller supporting member 5 toward a reverse direction to the driving roller 3. For example, the elastic member 6 is a spring.

The charging roller 7 is a roller that charges the transportation belt 2. The absorption roller 8 is a roller that nips the print sheet 101 with the driving roller 3 through the transportation belt 2. The discharging brush 9 is arranged at a prior stage of the recording head 1 and discharges the print sheet 101 or the transportation belt 2. Bias voltage is applied to the charging roller 7, the absorption roller 8 and the discharging brush 9 are electrically connected to a ground, and thereby the print sheet 101 is electrostatically absorbed onto the transportation belt 2.

The cleaning unit 10 cleans the transportation belt 2. Specifically, the cleaning unit 10 removes residual ink on the transportation belt 2. The cleaning supporting member 11 supports the cleaning unit 10.

Specifically, as shown in FIG. 1 for example, the cleaning unit 10 makes contact with the transportation belt 2 at a position opposite to the driven roller 4; and the cleaning supporting member 11 (a) is fixed to the cleaning unit 10 and (b) is connected to the shaft 4a of the driven roller 4 such that the cleaning unit 10 moves together with the driven roller 4 and the shaft 4a of the driven roller 4 is rotatable.

Specifically, the cleaning unit 10 moves together with movement of the driven roller 4 corresponding to expansion and contraction of the elastic member 6.

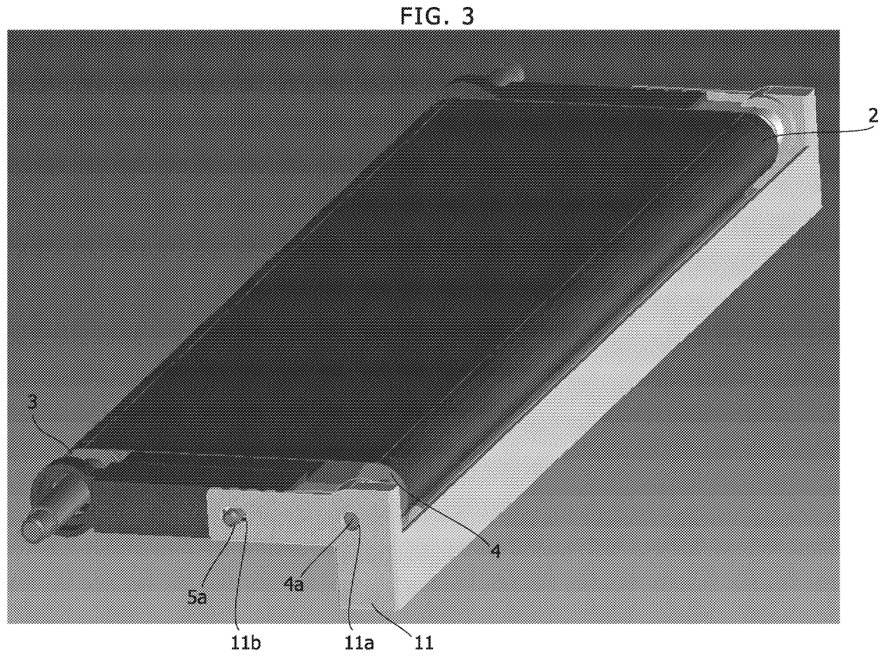

FIG. 3 shows a perspective-view diagram that indicates an example of a cleaning supporting member 11 in FIG. 1. As shown in FIG. 3 for example, the cleaning supporting member 11 includes a hole 11a in which the shaft 4a of the driven roller 4 is arranged. Arranging the shaft 4a of the driven roller 4 in the hole 11a connects the cleaning supporting member 11 to the shaft 4a of the driven roller 4 such that shaft 4a of the driven roller 4 is rotatable.

Further, the roller supporting member 5 includes a rotation regulating unit 5a configured to regulate rotation of the cleaning supporting member 11. In this embodiment, as shown in FIG. 3 for example, the cleaning supporting member 11 includes a rotation regulating hole 11b and the roller regulating member 5a is a protrusion arranged in the rotation regulating hole 11b. The rotation regulating unit 5a makes contact with the rotation regulating hole 11b and thereby rotation of the cleaning supporting member 11 around the hole 11a (i.e. the shaft 4a) as a center is regulated.

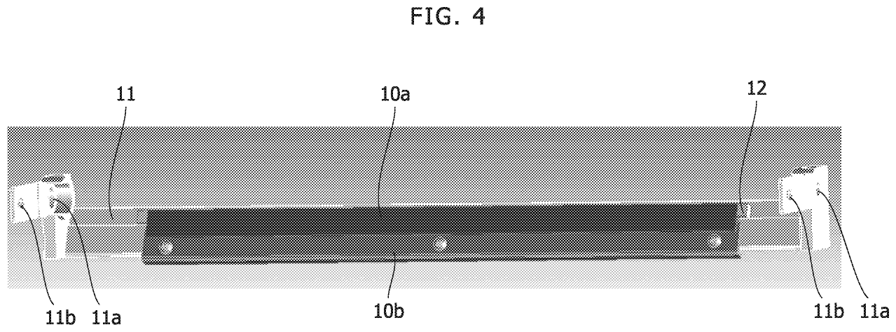

FIG. 4 shows a perspective-view diagram that indicates an example of the cleaning supporting member 11, a blade member 10a, and a blade supporting member 10b in FIG. 1. In this embodiment, the cleaning unit 10 includes a cleaning blade member 10a configured to make contact with the transportation belt 2, and a blade supporting member 10b to which the cleaning blade member 10a is fixed. As shown in FIG. 4 for example, the blade supporting member 10b is fixed to the cleaning supporting member 11. Here, the cleaning blade member 10a is a rubber-made and plate-shaped elastic member.

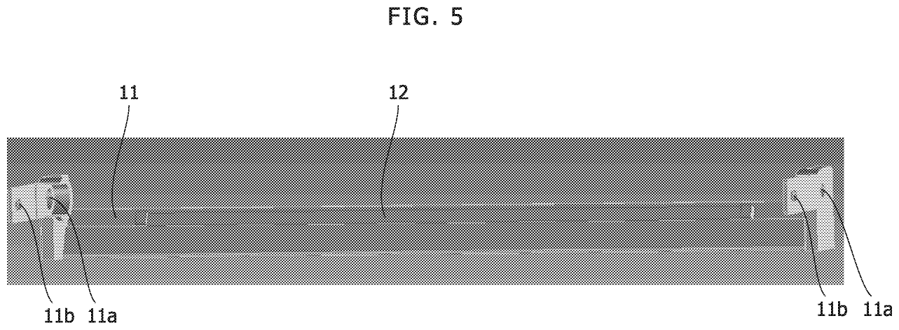

FIG. 5 shows a perspective-view diagram that indicates an example of an ink absorption member 12 in FIG. 1. The ink absorption member 12 absorbs residual ink collected from the transportation belt 2 by the cleaning unit 10. As shown in FIG. 5 for example, the ink absorption member 12 is fixed to the cleaning supporting member 11. Specifically, the ink absorption member 12 covers both end parts in a longitudinal direction and a back side of the cleaning blade member 10a, and absorbs ink collected by the cleaning blade member 10a.

The following part explains a behavior of the aforementioned image forming apparatus 1.

The driving roller 3 rotates and thereby the transportation belt 2 rotates. The print sheet 101 is nipped by the absorption roller 8 and is transported by the transportation belt 2 such that the print sheet 101 passes at an ink ejection position of the recording head 1. Further, the recording head 1 is controlled by a controller (not shown) and thereby ejects ink onto the print sheet 101 correspondingly to an image to be printed.

Due to such printing operation, ink, paper dust or the like is attached to the transportation belt 2, but removed from the transportation belt 2 by the cleaning unit 10.

The elastic member 6 adds force to the driven roller 4 through the roller supporting member 5, but moves in a transportation direction of the print sheet 101 due to fluctuation of a tension status of the transportation belt 2 while the transportation belt 2 is rotating. The cleaning unit 10 is connected to a shaft of the driven roller 4 with the cleaning supporting member 11 and moves together with the driven roller 4, and therefore, even if the driven roller 4 moves, a contact status of the cleaning unit 10 (the cleaning blade member 10a) to the transportation belt 2 does not fluctuate.

As mentioned, in the aforementioned embodiment, the recording head 1 ejects ink corresponding to an image to be printed. The transportation belt 2 transports a print sheet on which the image to be printed is formed. The transportation belt 2 is hitched around the driving roller 3 and the driven roller 4; force is added to the driven roller 4 toward a reverse direction to the driving roller 3; and the cleaning unit 10 makes contact with the transportation belt 2 at a position opposite to the driven roller 4. Further, the cleaning supporting member 11 (a) is fixed to the cleaning unit 10 and (b) is connected to the shaft 4a of the driven roller 4 such that the cleaning unit 10 moves together with the driven roller 4 and the shaft 4a of the driven roller 4 is rotatable.

Consequently, even if the driven roller 4 moves, a relative position of the cleaning unit 10 to the transportation belt 2 does not vary, and therefore, the transportation belt 2 is favorably cleaned by the cleaning unit 10.

It should be understood that various changes and modifications to the embodiments described herein will be apparent to those skilled in the art. Such changes and modifications may be made without departing from the spirit and scope of the present subject matter and without diminishing its intended advantages. It is therefore intended that such changes and modifications be covered by the appended claims.

What is claimed is:

1. An image forming apparatus, comprising:
a recording head configured to eject ink corresponding to an image to be printed;
a transportation belt configured to transport a print sheet on which the image to be printed is formed;
a driving roller;
a driven roller;
a cleaning unit configured to clean the transportation belt; and
a cleaning supporting member configured to support the cleaning unit;
wherein the transportation belt is hitched around the driving roller and the driven roller;
force is added to the driven roller toward a reverse direction to the driving roller;
the cleaning unit makes contact with the transportation belt at a position opposite to the driven roller; and
the cleaning supporting member (a) is fixed to the cleaning unit and (b) is connected to a shaft of the driven roller such that the cleaning unit moves together with the driven roller and the shaft of the driven roller is rotatable.

2. The image forming apparatus according to claim 1, further comprising:
a roller supporting member configured to support the shaft of the driven roller such that the shaft of the driven roller is rotatable; and
an elastic member configured to add force to the driven roller through the roller supporting member toward a reverse direction to the driving roller;
wherein the roller supporting member comprises a rotation regulating unit configured to regulate rotation of the cleaning supporting member.

3. The image forming apparatus according to claim 2, wherein the cleaning supporting member comprises a rotation regulating hole; and
the rotation regulating unit is a protrusion arranged in the rotation regulating hole.

4. The image forming apparatus according to claim 1, wherein the cleaning unit comprises a cleaning blade member configured to make contact with the transportation belt, and a blade supporting member to which the cleaning blade member is fixed; and
the blade supporting member is fixed to the cleaning supporting member.

5. The image forming apparatus according to claim 1, further comprising an ink absorption member configured to absorb ink collected from the transportation belt by the cleaning unit;
wherein the ink absorption member is fixed to the cleaning supporting member.
